(19) United States
(12) Patent Application Publication
(10) Pub. No.: US 2010/0209836 A1
(43) Pub. Date: Aug. 19, 2010

(54) COLOR TONER FOR ELECTROPHOTOGRAPHY

(75) Inventors: Kentaro Iwaki, Shizuoka (JP); Kimiaki Shiratori, Shizuoka (JP); Yoshihito Suwa, Shizuoka (JP); Nobuyuki Aoki, Shizuoka (JP)

Correspondence Address: JORDAN AND HAMBURG LLP, 122 EAST 42ND STREET, SUITE 4000, NEW YORK, NY, 10168, US

(73) Assignee: TOMOEGAWA CO., LTD., Tokyo (JP)

(21) Appl. No.: 12/672,454

(22) PCT Filed: Jul. 23, 2008
(86) PCT No.: PCT/JP2008/063155

§ 371 Date: Feb. 5, 2010

(30) Foreign Application Priority Data
Aug. 7, 2007 (JP) 2007-205054
Dec. 17, 2007 (JP) 2007-324559

(51) Int. Cl. G03G 9/087; G03G 9/09; G03G 9/08

(52) U.S. Cl. 430/108.11; 430/108.1; 430/108.4

(57) ABSTRACT

A color toner for electrophotography comprises, at least, a binder resin, a colorant and an antistatic composition. The antistatic composition comprises as the main components: (A) at least one member selected from a compound containing an ether linkage(s) and/or ester linkage(s) and a (co)polymer containing an ether linkage(s) and/or ester linkage(s); and (B) a component obtained by treating a metal salt of an alkali or alkaline earth metal with a compound capable of adsorbing anions.

### TECHNICAL FIELD

The present invention relates color toners for forming images in electrophotography, electrostatic recording and the like.

### BACKGROUND ART

In electrophotography, systems are generally adopted in which electrically latent images are formed by various methods, onto which toners are deposited to elicit the images, before transferring the images onto recording media such as papers. The toners for development used therefor are electrified by various frictional electrification methods to be used as having positive or negative charges depending on the polarity of the latent images to be developed.

In addition, developers which provide sufficient image densities at low development potentials and low transfer potentials and show no ground fogging are needed to be extended in life, since machine designing in consideration of economy and environmental awareness is desired in recent years. Extension of life of developers will contribute to reducing unit prices of copying and to slowing down renewal cycles of members of developing machines, leading to a reduction of discarded members.

Also, in order to have both good economy and miniaturization of machines, a number of full-color MFP's and printers which operate on the basis of non-magnetic, one-component development system are available on the market especially for personal and SOHO uses. Even for such highly economical, small-size full-color printers, requirement for image quality is high, so that less ground fogging, less toner consumption, no toner scattering inside the machine and stable image output are desired without being influenced by changes in the installation environment during the period from the start of use to an exchange of toner cartridges.

Conventionally, in order to obtain such developers in monochrome toners, electrical resistances of toners have been controlled to stabilize the amount of electrification by means of type selection and added amount of carbon black, selection of charge control agents and external additives, adjustment of carriers and the like.

In case of color toners, however, because usable color materials are limited for convenience of color reproduction and carbon black cannot be used in a procedure for stabilizing electrification, control of electrical resistances has been difficult, preventing the amount of electrification to be sufficiently stabilized.

In particular, in the non-magnetic, one-component development system, distinct phenomena in which electrification between toner particles may be promoted by an agitator provided to feed the toner toward electrifying members, or a newly fed toner may be prevented from being electrified when a toner retaining a large amount of electrification is resident on developing rollers may occur, easily making the amounts of electrification of toner particles uneven.

When the amounts of electrification of toner particles are uneven, such problems as toner scattering inside the machine, an increase of ground fogging due to less electrified toners and an increase of toner consumption due to an increase in thickness of toner layers on developing rollers may be caused.

Also, since color toners contain a large amount of mold release agents to correspond to the recent low-temperature fixation, they tend to lose stability of electrification along with an increase in the number of sheets printed due to migration of the mold release agents to carriers (in case of non-magnetic, one-component development system, migration of the mold release agents to electrifying members) and fusion of the mold release agents to developing machine members, thereby preventing sufficient adaptation to extension of life.

For example, a method in which an electrically conductive external additive is applied to toner surfaces in order to stabilize the amounts of electrification is proposed (for example, refer to Patent Reference 1.) This method, however, requires a large amount of an electrically conductive external agent to be applied to the toner surfaces, causing degradation of image density along with an increase in the number of sheets printed due to deterioration in toner fluidity, with insufficient extension of life. Further, another problem existed that sharpness of letters may degrade or environmental characteristics may deteriorate due to the electrically conductive external additive detaching from the toner to be transferred to recording media.

Patent Reference 1: Japanese Unexamined Patent Publication No. 1990-7071

### DISCLOSURE OF THE INVENTION

### Problems to be Solved by the Invention

The present invention has been made in the light of the problems as described above and has an object to provide color toners for electrophotography which provide sufficient image densities and show no ground fogging at low development potentials and low transfer potentials and are extended in life. It also has an object to provide color toners for electrophotography which, when used as non-magnetic, one-component toners, have less ground fogging, less toner consumption and no toner scattering inside the machine and output stable images without being influenced by changes in the installation environment during the period from the start of use to an exchange of toner cartridges.

### Means for Solving the Problems

The present invention has successfully solved the problems described above by means of technical constitution to be described below.

(1) A color toner for electrophotography containing, at least, a binder resin, a colorant and an antistatic composition which comprises as the main components:

(A) at least one member selected from a compound containing an ether linkage(s) and/or ester linkage(s) and a (co)polymer containing an ether linkage(s) and/or ester linkage(s); and

(B) a component obtained by treating a metal salt of an alkali metal or alkaline earth metal with a compound capable of adsorbing anions.

(2) The color toner for electrophotography according to (1) above, wherein the metal salt is lithium trifluoromethanesulfonate.

(3) The color toner for electrophotography according to (1) above, wherein the antistatic composition is contained in an amount of 0.1 part by weight or more and less than 1.5 parts by weight, based on 100 parts by weight of the binder resin.

(4) The color toner for electrophotography according to (1) above, which is a non-magnetic, two-component toner.

(5) The color toner for electrophotography according to any one of (1) to (3) above, which is a non-magnetic, one-component toner.

(6) The color toner for electrophotography according to (5) above, further containing a mold release agent in an amount of 3 to 15% by weight.

(7) The color toner for electrophotography according to (5) above, wherein a method for development is a jumping phenomenon.

(8) The color toner for electrophotography according to (5) above, which has a volume average particle diameter of 5 to 8 μm and a number percent of particles 5 μm or less in diameter of 10 to 50%.

### EFFECT OF THE INVENTION

According to the present invention, color toners for electrophotography which provide sufficient image densities and show no ground fogging at low development potentials and low transfer potentials and are extended in life may be provided.

Also, according to the present invention, since electrical resistances of toners can be adjusted with no assistance from electrically conductive external additives, color toners for electrophotography which will undergo no deterioration in sharpness of letters may be provided.

Further, according to the present invention, color toners for electrophotography which, when used as non-magnetic, one-component toners, have less ground fogging, less toner consumption and no toner scattering inside the machine and output stable images, without being influenced by changes in the installation environment during the period from the start of use to an exchange of toner cartridges may be provided.

In addition, according to the present invention, since electrical resistances of toners can be adjusted with no assistance from electrically conductive external additives and fluidity of the toners will not deteriorate, when used as non-magnetic, one-component toners, color toners for electrophotography which have stabilized image densities and can retain sharpness of letters may be provided.

### BEST MODE FOR CARRYING OUT THE INVENTION

Materials for composing the color toners for electrophotography according to the present inventions (hereinafter referred to as the toner) will now be described in detail.

(Antistatic composition)

[Component (A)]

Component (A) to be used according to the present invention is at least one member selected from a compound containing an ether linkage(s) and/or ester linkage(s) and a (co)polymer containing an ether linkage(s) and/or ester linkage(s).

The component (A) described above is effective in increasing solubility and dissociation stability of metal salts in the composition according to the present invention.

Examples of compounds containing an ether linkage(s) and/or ester linkage(s) to be used according to the present invention include organic compounds having a group represented by the general formula —{O(AO)ₙ}—, wherein A is an alkylene group having two to four carbon atoms and n is an integer of 1 to 7.

Organic compounds to be used as the compound (A) according to the present invention may be produced, for example, by a general method for producing ester compounds, using as raw materials a hydroxyl compound obtained by adding 1 to 7 moles of an alkylene oxide having two to four carbon atoms to 1 mole of a branched-chain aliphatic alcohol and a dibasic acid.

Examples of hydroxyl compounds described above include those made of 1 to 7 moles of ethylene oxide, 1 to 4 moles of propylene oxide or 1 to 3 moles of butylene oxide added to 1 mole of propanol, 1 to 6 moles of ethylene oxide or 1 to 3 moles of propylene oxide added to 1 mole of butanol, 1 to 2 moles of ethylene oxide added to 1 mole of hexanol, 1 to 5 moles of ethylene oxide, 1 to 3 moles of propylene oxide or 1 to 2 moles of butylene oxide added to 1 mole of pentanol, 1 to 5 moles of ethylene oxide, 1 to 3 moles of propylene oxide or 1 to 3 moles of butylene oxide added to 1 mole of octanol, and 1 to 4 moles of ethylene oxide, 1 to 2 moles of propylene oxide or 1 to 2 moles of butylene oxide added to 1 mole of nonanol, respectively.

Among these hydroxyl compounds, 2-(2-butoxyethoxy)ethanol made of 2 moles of ethylene oxide added to 1 mole of butanol and 2-butoxyethanol made of 1 mole of ethylene oxide added to 1 mole of butanol provide a good balance with processability.

Also, examples of dibasic acids as described above include carboxylic acids, such as adipic acid, sebacic acid, phthalic acid and succinic acid as well as anhydrides of such carboxylic acids.

Preferred examples of organic compounds to be used according to the present invention include bis[2-(2-butoxyethoxy)ethyl]adipate and bis(2-butoxyethyl)phthalate.

Compounds to be used as the component (A) according to the present invention also include polymerizable monomers, prepolymers and oligomers containing an ether linkage(s) and/or ester linkage(s).

Specific examples include polymerizable monomers, prepolymers and oligomers, such as ethylene glycol di(meth)acrylate, diethylene glycol (meth)acrylate, dipropylene glycol di(meth)acrylate, triethylene glycol di(meth)acrylate, tripropylene glycol di(meth)acrylate, trimethylolpropane ethoxy(meth)acrylate, trimethylolpropane tri(meth)acrylate, neopentyl glycol di(meth)acrylate, tetraethylene glycol di(meth)acrylate and ethoxydiethylene glycol (meth)acrylate, such as polyethylene glycol di(meth)acrylates and polypropylene glycol (meth)acrylates.

Also, polyether-based polyols, such as polypropylene glycol, polymer polyol and polytetramethylene glycol, polyester-based polyols, such as adipate-based polyols, phthalate-based polyols, polycaprolactam-based polyols and polycarbonate-based polyols as wells as polybutadiene polyols and acrylic polyols can be mentioned.

The compounds containing an ether linkage(s) and/or ester linkage(s) to be used as the component (A) according to the present invention can be used as they are or as solutions in which they are dissolved in solvents.

Examples of (co)polymers containing an ether linkage(s) and/or ester linkage(s) to be used as the component (A) according to the present invention include polyalkylene oxide resins, such as polyoxyethylene, polyoxypropylene, polyoxytetramethylene and ethylene oxide-propylene oxide copolymer, polyetheresteramide/polyester resins, such as polyethyleneglycol-polyamide copolymers having polyether segments, polyethylene glycol-methacrylate copolymers, polyethylene glycol-based polyesteramide copolymers and polyethylene glycol-based polyester elastomers as wells as polyurethane resins having segments of polyethylene glycol, polypropylene glycol, polybutylene glycol and the like.

Preferred are polyalkylene oxide resins, polyetheresteramide resins and polyurethane resins.

[Component (B)]

The component (B) is obtained by treating salts of alkali metals or alkaline earth metals with a component capable of adsorbing anions to absorb anions.

Metal salts to be used for the component (B) are composed of cations of alkali metals or alkaline earth metals and ion dissociable anions.

Examples of alkali metals or alkaline earth metals include Li, Na, K, Mg and Ca.

Preferred as cations are Li⁺, Na⁺ and K⁺ having small ion diameters and particularly preferred is lithium ion (Li⁺).

Examples of anions corresponding to alkali metal or alkaline earth metal cations of the metal salts described above include Cl⁻, Br⁻, F⁻, I⁻, NO₃⁻, SCN⁻, ClO₄⁻, CF₃SO₃⁻, BF₄⁻, (CF₃SO₂)₂N⁻ and (CF₃SO₂)₃C⁻.

Preferred are ClO₄⁻, CF₃SO₃⁻, (CF₃SO₂)₂N⁻ and (CF₃SO₂)₃C⁻ and more preferred are CF₃SO₃⁻, (CF₃SO₂)₂N⁻ and (CF₃SO₂)₃C⁻.

There are a number of metal salts that are composed of the cations and anions described above and, among them, preferred are lithium perchlorate LiClO₄, sodium perchlorate NaClO₄, magnesium perchlorate Mg(ClO₄)₂, potassium perchlorate KClO₄, lithium trifluoromethanesulfonate LiCF₃SO₃, lithium bis(trifluoromethanesulfonyl)imide Li(CF₃SO₂)₂N, potassium bis(trifluoromethanesulfonyl)imide K(CF₃SO₂)₂N, sodium bis(trifluoromethanesulfonyl)imide Na(CF₃SO₂)₂N, lithium tris(trifluoromethanesulfonyl)methide Li(CF₃SO₂)₃C and sodium tris(trifluoromethanesulfonyl)methide Na(CF₃SO₂)₃C.

Among them, lithium perchlorate, lithium trifluoromethanesulfonate, lithium bis(trifluoromethanesulfonyl)imide and lithium tris(trifluoromethanesulfonyl)methide are more preferred.

In particular, lithium trifluoromethanesulfonate, lithium bis(trifluoromethanesulfonyl)imide and lithium tris(trifluoromethanesulfonyl)methide are preferred and addition of these in small amounts may reduce electrical resistances so that the effects described above may more effectively be exerted.

The component (B) to be used according to the present invention may be obtained by treating at least one of these metal salts with a component capable of adsorbing anions to absorb anions.

As the components capable of adsorbing anions described above, known compounds such as synthetic hydrotalcites mainly based on Mg and Al, inorganic ion exchangers based on Mg—Al, Sb, Ca or the like, and (co)polymers having ion products for immobilizing anions in their chains are useful.

Specific examples include synthetic hydrotalcites (trade names Kyoward KW-2000 and Kyoward KW-1000, Kyowa Chemical Industry Co., Ltd.), a synthetic adsorbent (trade name Q-fine 2000, Tomita Pharmaceutical Co., Ltd.) and an anion exchangeable ion exchange resin (DIAION DCA11, Nippon Rensui Co.).

The added amount of the component capable of adsorbing anions is from 0.01 to 5.0 equivalents, and preferably from 0.05 to 2.0 equivalents, based on 1 equivalent of the metal salt.

When the amount is less than 0.01 equivalent, an insufficient amount of anions will be adsorbed. On the other hand, when the amount exceeds 5.0 equivalents, antistatic effects may reach a saturation value, leading to an economic disadvantage.

When an anion exchangeable ion exchange resin is used as a component capable of adsorbing anions, hydroxyl ions are released from the ion exchange resin. It is therefore necessary to neutralize and remove the hydroxyl ions by addition of a carboxylic compound as a compound for capturing the hydroxyl ions.

The component capable of adsorbing anions may be removed by filtration, when the component (A) is liquid, or may be contained as it is in the antistatic composition.

According to the present invention, a method for treating the metal salts described above with a component capable of adsorbing anions may be any of the methods (1) to (7) described below.

(1) A method in which a metal salt is dissolved in a compound or solution thereof containing an ether linkage(s) and/or ester linkage(s), followed by treatment with a component capable of adsorbing anions.

(2) A method in which a metal salt and a component capable of adsorbing anions are simultaneously added to a compound or solution thereof containing an ether linkage(s) and/or ester linkage(s) for treatment.

(3) A method in which a component capable of adsorbing anions is added in advance to a compound or solution thereof containing an ether linkage(s) and/or ester linkage(s), followed by treatment while dissolving a metal salt.

(4) A method in which a metal salt is added to a (co)polymer containing an ether linkage(s) and/or ester linkage(s), followed by addition of a component capable of adsorbing anions.

(5) A method in which a metal salt and a component capable of adsorbing anions are simultaneously added to a (co)polymer containing an ether linkage(s) and/or ester linkage(s) for treatment.

(6) A method in which a (co)polymer containing an ether linkage(s) and/or ester linkage(s), to which a metal salt has been added, is dissolved in a suitable solvent, followed by treatment with addition of a component capable of adsorbing anions.

(7) A method in which a component capable of adsorbing anions is added in advance to a (co)polymer containing an ether linkage(s) and/or ester linkage(s), followed by treatment while dissolving a metal salt.

The antistatic composition according to the present invention is produced, for example, as follows.

First, an alkali metal or alkaline earth metal salt is dissolved in a component (A) comprising a compound or solution thereof containing an ether linkage(s) and/or ester linkage(s) to obtain a mixture.

The metal salt described above is dissolved in such a manner that the metal salt may be preferably from 0.1 to 80% by weight, and more preferably from 0.5 to 50% by weight, based on the total of the compound containing an ether linkage(s) and/or ester linkage(s) and the metal salt.

Also, when the component (A) is a (co)polymer containing an ether linkage(s) and/or ester linkage(s), the alkali metal or alkaline earth metal salt is homogenously added and blended in such a manner that the metal salt may be preferably from 0.1 to 50% by weight, and more preferably from 0.5 to 30% by weight, based on the total of the (co)polymer containing an ether linkage(s) and/or ester linkage(s) and the metal salt to obtain a mixture. If necessary, heating is provided for dissolving and blending.

When the amount of the metal salt is below the ranges described above, sufficient antistatic effects may not be obtained while the amount of the metal salt is above the ranges described above, antistatic effects may hardly improve, leading to an economic disadvantage.

Next, a component capable of adsorbing anions is added to the mixture described above for anion adsorption treatment to obtain the antistatic composition according to the present invention.

When the mixture does not contain the (co)polymer described above, conditions for anion adsorption treatment are typically a temperature of 20 to 100° C. and a period of 10 to 120 minutes and preferably a temperature of 30 to 90° C. and a period of 20 to 90 minutes.

When the mixture contains the (co)polymer described above, conditions are usually a temperature of −20 to 200° C. and a period of 1 to 60 minutes and preferably a temperature of −10 to 180° C. and a period of 3 to 30 minutes, depending on the (co)polymer.

Outside the ranges described above, capability of adsorbing anions may not sufficiently be exerted and the polymers may unfavorably be degraded.

[Other Components]

The antistatic composition according to the present invention may further contain, as other components, at least one selected from the group of thermoplastic resins, unvulcanized rubbers and thermoplastic elastomers.

As the thermoplastic resins described above, the following resins may be used, including those corresponding to the (co)polymers containing an ether linkage(s) and/or ester linkage(s) described above.

Namely, they include thermoplastic resins, such as polyolefinic resins (polyethylene, polypropylene, polybutene, EVA resin, EVOH resin and the like), polystyrenic resins (polystyrene, AS resin, ABS resin, AXS resin and the like), polyamide resins (nylon 6, nylon 6,6, nylon 6,10, nylon 12 and the like), polyacetal resins, saturated polyesters (polyethylene terephthalate, polybutylene terephthalate, poly2,4-cyclohexyl dimethylene terephthalate, wholly aromatic polyesters and the like), polyacrylonitrile resins, polycarbonate resins, acrylic resins, vinyl chloride-based resins (vinyl chloride resins, vinylidene chloride resins and the like), fluororesins (polyvinyl fluoride, tetrafluoroethylene-hexafluoropropylene copolymer resins, tetrafluoroethylene-perfluoroalkylvinylether copolymer resins and the like), liquid crystal polyesters, polyacrylates, polysulfones, polyphenylene ethers, unsaturated polyester resins, polyurethane resins, diallyl phthalate resins, polyimides and silicone resins.

Preferred are polyolefinic resins, polystyrenic resins, polyamide resins, polyurethane resins and polyacrylonitrile resins.

These resins may be used alone or in combination of two or more.

As the unvulcanized rubbers described above, the following rubbers may be used.

Namely, they include natural rubbers, isoprene rubbers, butadiene rubbers, styrene-butadiene rubbers (SBR), butyl rubbers, ethylene-propylene rubbers (EPM, EPDM), chloroprene rubbers (CR), acrylonitrile-butadiene rubbers (NBR), chlorosulfonated polyethylene (CSM), epichlorohydrin rubbers (CO, ECO), chlorinated polyethylene, silicone rubbers, fluorinated rubbers and urethane rubbers.

These rubbers may be used alone or in combination of two or more.

As the thermoplastic elastomers described above, the following elastomers may be used, including those corresponding to the component (A).

Namely, they include polyamide-based elastomers (TPAE), polyether/polyester-based thermoplastic polyester elastomers (TPEE), polyurethane-based thermoplastic elastomers (TPU) and styrenic thermoplastic elastomers (TPS) (specifically, styrene-ethylene-butene-styrene copolymer (SEBS), styrene-ethylene-propylene-styrene copolymer (SEPS), styrene-ethylene-ethylene-propylene-styrene copolymer (SEEPS) and styrene-butadiene-butylene-styrene copolymer (partially hydrogenated styrene-butadiene-styrene copolymer, SBBS)).

Also, the thermoplastic resins, unvulcanized rubbers and thermoplastic elastomers described above may appropriately be used in combination as other components.

In order to obtain an antistatic composition containing at least one selected from the group of the other components exemplified above, namely the thermoplastic resins, unvulcanized rubbers and thermoplastic elastomers, the components (A) and (B) are incorporated so that they are contained in an amount of 0.01 part by weight or more and 50.0 parts by weight or less, and preferably in an amount of 0.05 part by weight or more and 30.0 parts by weight or less in total, based on 100 parts by weight of the other components.

When the total of the components (A) and (B) is less than 0.01 part by weight, electrical properties will be insufficient. On the other hand, when they are contained at more than 50 parts by weight, electrical properties will be good but viscosity will remarkably decrease, leading to a degradation of processability.

Methods for incorporating the components (A) and (B) and other components are not particularly limited and any known procedures may be used.

For example, they may be dry-blended using a Henschel mixer, ribbon blender, super mixer, tumbler and the like.

Also, they may be melt-blended using a double- or single-screw extruder, Banbury mixer, plastomill, Ko-kneader, roll and the like.

If necessary, the method may be carried out under an inert gas atmosphere such as nitrogen.

The antistatic composition according to the present invention may further be incorporated with known additives such as antioxidants, thermal, stabilizers, ultraviolet absorbers, flame retardants, flame retardant auxiliaries, colorants, pigments, antibacterial and antifungal agents, photoprotective agents, plasticizers, tackifiers, dispersants, antifoaming agents, catalytic hardeners, curing agents, levelling agents, coupling agents, fillers, vulcanizing agents, vulcanizing accelerators, organic peroxides and coagents.

The antistatic composition according to the present invention obtained by the methods described above may be formed by forming methods, such as compression molding, transfer molding, extrusion molding, blow molding, calendering, casting, pasting, pulverization, reaction molding, thermoforming, blow molding, rotational molding, vacuum molding, cast molding and gas-assisted molding.

When polymerizable monomers, prepolymers or oligomers containing an ether linkage(s) and/or ester linkage(s) are used as the component (A) in the antistatic composition according to the present invention, molded articles can also be obtained by photocuring by adding photopolymerization initiators (cast molding).

Photoinitiators to be used are known, examples of which include benzophenone, 4-phenyl benzophenone, 4-benzoyl-4′-methyl diphenyl benzophenone, 3,3′-dimethyl-4-methoxy benzophenone, benzoin, benzoin methyl ether, benzoin ethyl ether, benzoin isopropyl ether, benzoin isobutyl ether, benzyl dimethyl ketal, diethoxy acetophenone, 2-hydroxy-2-methyl-1-phenyl-1-propanone, 2-methyl-1-[4-(methylthio)phenyl]-2-morpholino-1-propanone, 1-hydroxycyclohexyl phenyl ketone, thioxanthone, 2-chlorothioxanthone, 2,4-dimethylthioxanthone, 2-isopropylthioxanthone, 2,4-diethylthioxanthone, 2,4,6-trimethyl benzoyl diphenyl phosphine oxide, camphor quinone, anthraquinone, benzyl and phenyl methyl glyoxylate.

When the polyols described above and the like are used as the component (A), polyurethane foam molded articles can also be obtained by reaction molding using diisocyanate compounds along with amines and surface active agents.

Amines to be used are known, examples of which include triethylene dilaurate, N-alkyl morpholines, N-alkyl imidazoles, 1,8-diazabicyclo[5,4,0]-undecen-7, bis(2-dimethylaminoethyl)ether, N,N,N′,N′-tetramethylhexamethylene diamine, N,N,N′,N″,N″-pentamethyldiethylene triamine, N,N-dimethylcyclohexyl amine, N,N′-dimethanolamine and N,N′-diethanolamine.

Surface active agents to be used are known, examples of which include silicone-based surface active agents (trade name SH-193, Toray Silicone Co., Ltd. and trade name L-520, UCC Co., Ltd.).

Diisocyanate compounds to be used are known, examples of which include tolylene diisocyanate, diphenylmethane diisocyanate, polymethylene polyphenyl polyisocyanate, tolydine diisocyanate, naphthalene diisocyanate, hexamethylene diisocyanate, isophorone diisocyanate, xylylene diisocyanate, hydrogenated xylylene diisocyanate and dicyclohexylmethane diisocyanate.

The amount of the antistatic composition described above incorporated in the toner according to the present invention is preferably 0.1 part by weight or more and less than 1.5 parts by weight, based on 100 parts by weight of the binder resin.

(Binder Resin)

Examples of binder resins to be used according to the present invention include homopolymers and copolymers of styrenes, such as styrene and chlorostyrene, monoolefins, such as ethylene, propylene, butylene and isobutylene, vinyl esters such as vinyl acetate, vinyl propionate, vinyl benzoate and vinyl butyrate, esters of α-methylene aliphatic monocarboxylic acids, such as methyl acrylate, ethyl acrylate, butyl acrylate, octyl acrylate, dodecyl acrylate, phenyl acrylate, methyl methacrylate, ethyl methacrylate, butyl methacrylate and dodecyl methacrylate, vinyl ethers, such as vinyl methyl ether, vinyl ethyl ether and vinyl butyl ether, vinyl ketones, such as vinyl methyl ketone, vinyl hexyl ketone and vinyl isopropenyl ketone and cyclic olefins having a double bond(s), such as cyclobutene, cyclopentene, cyclohexene, cyclopentadiene, cyclohexadiene, norbornene and dicyclopentadiene.

Also, polyester resins produced from carboxylic acids such as maleic acid, fumaric acid and phthalic acid and alcohols such as bisphenol A (including EO/PO adducts) and ethylene glycol may be mentioned for example.

Among them, styrene-(meth)acrylate copolymer resins, cyclic olefin copolymer resins such as ethylene-norbornene and polyester resins are preferably used.

From the viewpoint of durability, polyester resins are preferably used.

In case of a non-magnetic toner, the amount of the binder resin according to the present invention is preferably from 80 to 95 parts by weight, based on 100 parts by weight of the toner.

(Colorant)

Colorants will now be described.

As yellow colorants, as those based on pigments, compounds represented by condensed azo compounds, isoindolinone compounds, anthraquinone compounds, azo metal complex methine compounds and allyl amide compounds are used.

Specifically, C. I. Pigment Yellow 3, 7, 10, 12, 13, 14, 15, 17, 23, 24, 60, 62, 73, 74, 75, 83, 93, 94, 95, 99, 100, 101, 104, 108, 109, 110, 111, 117, 122, 123, 128, 129, 138, 139, 147, 148, 150, 155, 166, 168, 169, 177, 179, 180, 181, 183, 185, 191:1, 191, 192, 193 and 199 are preferably used.

As those based on dyes, C. I. Solvent Yellow 33, 56, 79, 82, 93, 112, 162 and 163 and C. I. Disperse Yellow 42, 64, 201 and 211 may be mentioned for example.

As magenta colorants, condensed azo compounds, diketopyrolopyrrole compounds, anthraquinones, quinacridone compounds, basic dye lake compounds, naphthol compounds, benzimidazolone compounds, thioindigo compounds and perylene compounds are used.

Specifically, C. I. Pigment Red 2, 3, 5, 6, 7, 23, 48:2, 48:3, 48:4, 57:1, 81:1, 122, 146, 166, 169, 177, 184, 185, 202, 206, 220, 221, 238, 254 and 269 and C. I. Pigment Violet 19 are especially preferred.

As cyan colorants, copper phthalocyanine compounds and derivatives thereof, anthraquinone compounds, basic dye lake compounds and the like may be used.

Specifically, C. I. Pigment Blue 1, 7, 15, 15:1, 15:2, 15:3, 15:4, 60, 62 and 66 are particularly preferably used.

The added amount of a colorant is from 2 to 20 parts by weight and preferably from 2 to 15 parts by weight based on 100 parts by weight of the binder resin. Further, in consideration of preferred transmission of toner images through OHP films, the colorant is used preferably in the range of less than 12 parts by weight and, usually, most preferably in the range of 3 to 9 parts by weight.

(Charge Control Agent)

Also, according to the present invention, charge control agents may be added, if necessary.

When charge control agents are added, examples of positively charging charge control agents include nigrosine-based dyes, quaternary ammonium salt-based compounds, triphenylmethane-based compounds, imidazole-based compounds and polyamine resins.

Examples of negatively charging charge control agents include azoic dyes containing metals such as Cr, Co, Al and Fe, metal salicylate compounds, metal alkylsalicylate compounds, calixarene compounds, boron complexes and high molecular weight charge control agents.

The added amount is preferably from 0.05 to 10 parts by weight based on 100 parts by weight of the binder resin.

(Mold Release Agent)

The toners constituting the present invention may be incorporated with mold release agents, if necessary.

Specific examples of mold release agents to be dispersed in the toners may include paraffin waxes, polyolefin waxes, Fischer Tropsch wax, ester-based waxes, modified waxes having aromatic groups, hydrocarbon compounds having alicyclic groups, natural waxes, long-chain carboxylic acids having long-chain hydrocarbon chains with 12 or more carbons, fatty metal salts, fatty amides and fatty bisamides.

These mold release agents may be used alone or in combination of two or more. When the added amount of mold release agents to be added to the binder resin is less than 30 parts by weight and preferably from 2 to 20 parts by weight, based on 100 parts by weight of the binder resin, the mold release agents will preferably be contained in the toner at 3 to 15% by weight. When the mold release agents are at less than 3% by weight, the toners will tend to stick to thermal fixing rollers, possibly creating offset images or causing copying papers to stick and curl, or the resin will tend to be less fusible, possibly degrading image fixing strength. On the other hand, when the mold release agents are at more than 15% by weight, the mold release agents will separate from the toner, possibly sticking to various members inside copying machines to cause degradation in quality of printing and, furthermore, failures of the copying machines.

A process for producing the toner according to the present invention will now be described.

Predetermined amounts of a binder resin, a colorant and an antistatic composition and optionally a charge control agent and a mold release agent are weighed and blended to obtain a mixture.

Examples of mixing apparatuses include double-cone mixers, V-type mixers, drum-type mixers, super mixers, Henschel mixers and Nauta mixers.

Next, the mixture is hot melt-kneaded to homogenously disperse the colorant, the mold release agent, the antistatic composition and the charge control agent in the binder resin to obtain a kneaded product.

A hot-melt kneading machine of batch type (for example, pressurizing kneader or Banbury mixer) or continuous type is used for the kneading step. As a single-screw or double-screw, continuous extruder, a double-screw extruder of the type KTK from Kobe Steel, Ltd., a double-screw extruder of the type TEM from Toshiba Machine Co., Ltd., a double-screw extruder from KCK Co., a double-screw extruder of the type PCM from Ikegai Iron Works Co., a double-screw extruder from Kuriyama Seisakusho Co., a Ko-kneader from Buss AG and the like may be used. Also, open roll-type continuous kneaders are usable.

Then, the kneaded product is cooled.

For the cooling step, such procedures as calendering raw materials as kneaded by a twin-roll, double-steel belt and the like and then cooling with cold air or water are used.

Next, the kneaded product as cooled is ground.

In the grinding step, the kneaded product is coarsely ground by a crusher, hammer mill, feather mill or the like and finely ground by a jet mill, high-speed rotary mill, interparticle collision mill or the like to gradually grind to a predetermined toner particle size.

The toner is then classified by an elbow jet of inertial classification system, a microplex of centrifugal classification system, a DS separator, another dry air classifier or the like to obtain a classified toner having a predetermined particle diameter.

The coarse powder obtained during the classification step may be returned to the grinding step and the fine powder generated may be returned to the kneading step of added mixture for reuse.

Thereafter, a step of external addition is carried out when external additives are attached to the classified toner.

The classified toner is formulated with predetermined amounts of various external additives and the formulation is agitated and blended using a high-speed agitator or the like that applies shear force to the powder, such as a Henschel mixer or super mixer.

In so doing, heat is generated inside the external additive machine so that agglomerates may easily be formed. It is therefore preferred to adjust the temperature by cooling the surroundings of the vessel of the external additive machine with water. Further, the temperature of the materials in the vessel of the external additive machine is preferably at or below the control temperature that is lower by approximately 10° C. than the glass transition temperature of the resin.

Various inorganic or organic external additives may be used as external additives. For the purpose of improving flowability of the toners and inhibiting coagulation, inorganic fine powders of silica, titanium oxide, alumina, zinc oxide, magnesium oxide and the like are preferred.

The amount of an external additive to be mixed varies depending on the particular external additive used and the average particle diameter, the particle size distribution and the like of toner particles and may appropriately be selected so that the toners may have desired flowability. Generally 0.05 to 10 parts by weight and more typically 0.1 to 8 parts by weight, based on 100 parts by weight of the toner particles are preferred.

If the amount of the additive added is less than 0.05 parts by weight, the effect of improving flowability will be insufficient and the storage stability at high temperatures will degrade, while the amount is more than 10 parts by weight, the external additive may partly separate to undesirably cause filming on photoreceptors or deposit inside of a developer tank to cause deterioration of the electrification function of the developer and the like.

Also, in consideration of the stability of the external additive in high humidity conditions, it is more is preferred that inorganic fine powders are hydrophobicated by a treatment agent such as silane coupling agent. Further, when electrification properties are taken into consideration, negatively charging treatment agents such as dimethyldichlorosilane, monooctyltrichlorosilane, hexamethyldisilazane and silicone oil or positively charging treatment agents such as aminosilane may be used.

Furthermore, the toners according to the present invention may be incorporated with appropriate amounts of fine powders of titanium oxide, electrically conductive titanium, alumina, acrylic beads, silicone beads, polyethylene beads or the like as external additives for the purpose of antistatic auxiliaries, abrasives or the like and not for improving flowability. The amount of such additives is preferably from 0.005 to 10 parts by weight based on 100 parts by weight of the toner.

The toners according to the present invention are obtained by the process described above and have a volume average particle diameter preferably of 3 μm to 10 μm and more preferably of 5 μm to 8 μm. When the volume average particle diameter is less than 3 μm, ultrafine powder of less than 2 μm will increase, causing fogging, a decrease in image density, black spots on photoreceptors or filming, fusing at developing sleeves or layer thickness regulating blades or the like. On the other hand, when the particle diameter is more than 10 μm, resolution will decrease, preventing quality images from being obtained.

Also, the number percent of particles 5 μm or less in diameter is preferably from 10 to 50%.

The volume average particle diameter according to the present application is given by measuring the relative volume distribution for each particle diameter using a Coulter counter TA-II (Coulter, Inc.) through a 100 μm aperture tube.

The degree of circularity of the toners according to the present invention is from 0.80 to 0.98 and preferably from 0.90 to 0.96. When the degree of circularity is less than 0.80, flowability will be insufficient to decrease the amount of electrification to cause a decrease in image density and when the degree of circularity is more than 0.98, an excessive amount of electrification will increase the consumption of the toners.

The degree of circularity is represented as:

Degree of Circularity=π·(diameter of a circle equal in surface area to particle image)/(perimeter of particle image)

and given by a flow particle image analyzer (trade name FPIA-2000, Sysmex Corporation).

The toners obtained according to the present invention may be used for various fixation methods, such as so-called oilless and oil-applied thermal roll method, flash method, oven method and pressure fixation method.

In addition, they may be used as non-magnetic, one-component toners, non-magnetic, two-component toners and the like.

As carriers for two-component development systems, nickel, cobalt, iron oxide, ferrite, magnetite, iron, glass beads and the like may be used, for example. These carriers may be used alone or in combination of two or more. The carriers may preferably have an average particle diameter of 20 to 150 μm. Also, the surface of, the carriers may be coated with a coating agent such as a fluorine-based resin, acrylic resin or silicone-based resin. Also, a magnetic material may be dispersed in a binder resin.

When the toners according to the present invention are used for non-magnetic, one-component development systems, they will be effective in suppressing the amount of electrification of the toners in printing a large number of sheets, thereby providing a reduction in ground fogging phenomenon.

When they are used for non-magnetic, two-component development systems, they will be effective in suppressing the amount of electrification of the toners so that the toners may be less likely to electrostatically attach to carriers, providing for an extended life of developers.

Also, antistatic compositions to be used according to the present invention are pale in color. The toners according to the present invention are therefore easily colored and suitable to be used as color toners.

According to the present invention, non-magnetic, one-component color toners refer to those that are used for non-magnetic, one-component developing apparatuses, and the non-magnetic, one-component developing apparatuses refer to those having developing rollers at least whose surfaces to carry and feed toners are made of a rubber or metal and blade members whose surfaces, provided in proximity to or in forced contact with the developing rollers, are made of a rubber or metal, in which the developing rollers are fed with toners and the toners are applied by the blade members in such a manner that the toners may form thin layers while the toners are electrified so that electrostatic latent images are developed in a contacting or noncotacting (jumping) manner on latent image forming members for retaining the electrostatic latent images to be subsequently transferred to sheets.

The present invention will now be described in more detail with the use of examples.

### EXAMPLES

The present invention will be described with reference to examples below, to which the present invention is not limited in any way.

### Example 1

### Production of Antistatic Composition

To 100 parts of bis[2-(2-butoxyethoxy)ethyl]adipate (Sanko Chemical Industry Co., Ltd.) (70° C.) as an organic compound for component (A), lithium trifluoromethanesulfonate LiCF₃SO₃ (Morita Chemical Industries Co., Ltd.) as component (B) was added and dissolved to 10% by weight.

Then, after setting the solution at 60° C., a synthetic hydrotalcite (trade name “Kyoward KW-2000”, Kyowa Chemical Industry Co., Ltd.) as a component capable of adsorbing anions was added to 2% by weight and the solution was agitated at 60° C. for 60 minutes.

The solution was filtrated to obtain an antistatic composition (X) composed of a clear liquid.

The volume specific resistance of the obtained antistatic composition(X) was 4.1×10⁶ Ω·cm.

The volume specific resistance of the liquid was measured at an applied voltage of 1 volt using a digital multimeter TR6865 (Advantest Corporation).

(Production of Non-Magnetic Two-Component Toner and Developer)

Next, the following formulation was homogenously blended using a Henschel mixer (trade name “Henschel Mixer 20L”, Mitsui Mining Co., Ltd.) at 2,000 rpm for five minutes and then melt-kneaded using a double-screw kneader/extruder (trade name “PCM-30”, Ikegai Iron Works Co.) at 150 rpm with a discharge rate of 3.5 kg/hr. The kneaded product was calendered using a twin-roll and left to cool.

Binder resin: polyester resin (Mitsubishi Rayon Co., Ltd., Mw 25,000, Mn 5,000, Tg (shoulder) 60° C.) 100 parts by weight

Colorant: magenta pigment (trade name “Pigment 57-1”, Dainichiseika Color & Chemicals Mfg. Co., Ltd.) 5 parts by weight

Charge control agent: boron complex particles (trade name “LR-147”, Japan Carlit Co., Ltd.) 1.5 parts by weight

Antistatic composition (X) 0.25 part by weight

Mold release agent: wax (trade name “Carnauba Wax Powder No. 2”, S. Kato & Co.) 5 parts by weight

Then, the kneaded product as cooled was coarsely ground by a hammer mill and finely ground by a jet mill (trade name “200AFG”, Hosokawa Micron Corporation).

Classification was then performed using a dry air classifier (trade name “100ATP”, Hosokawa Micron Corporation) to obtain a classified toner having a volume average particle diameter of 7.1 μm and a degree of circularity of 0.925.

Next, an external additive comprising silica, impalpable resin powder and titanium oxide to be described below was added to 100 parts by weight of the classified toner and blending was performed using a 10 L Henschel mixer at 2,500 rpm for five minutes to obtain a toner (external addition step).

Silica (Clariant Japan, average primary particle diameter 17.5 nm, specific surface area 140 m²/g) 0.2 part by weight

Impalpable resin powder (trade name HYLAR 461, Ausimont S.p.A.) 0.3 part by weight

Titanium oxide (Nippon Aerosil Co., Ltd., average primary particle diameter 10 nm, BET specific surface area 65±10, treated with octylsilane) 0.5 part by weight

Thereafter, 7.5 parts by weight of the obtained toner and 92.5 parts by weight of a ferrite carrier 40 μm in average particle diameter (Kanto Denka Kogyo Co., Ltd.) were blended to obtain a magenta developer.

Further, in a manner similar to the above except for replacing the magenta pigment described above with a cyan pigment (trade name “ECB301”, Dainichiseika Color & Chemicals Mfg. Co., Ltd.) and a yellow pigment (trade name “Fast Yellow 74-16”, Sanyo Color Works, Ltd.), cyan and yellow developers were obtained.

As described above, a non-magnetic, two-component developer of Example 1 was produced.

### Example 2

In Example 2, in a manner similar to Example 1 except that the antistatic composition (X) was incorporated at 0.1 part by weight, a non-magnetic, two-component developer of Example 2 was obtained.

### Example 3

In Example 3, in a manner similar to Example 1 except that the antistatic composition (X) was incorporated at 1.0 part by weight and the binder resin was ethylene-norbornene copolymer resin (Ticona, Mw 78,000, Mn 6,500, Tg 58° C.), a non-magnetic, two-component developer of Example 3 was obtained.

### Comparative Example 1

In Comparative Example 1, in a manner similar to Example 1 except that the antistatic composition was not incorporated, a non-magnetic, two-component developer of Comparative Example 1 was obtained.

### Comparative Example 2

In Comparative Example 2, in a manner similar to Example 3 except that the antistatic composition was not incorporated, a non-magnetic, two-component developer of Comparative Example 2 was obtained.

### Example 4

### Production of Non-Magnetic, One-Component Toner

In Example 4, in a manner similar to Example 1 except that the polyester resin of the binder resin was a polyester resin (Mitsubishi Rayon Co., Ltd., Mw 30,000, Mn 5,500, Tg (shoulder) 61° C.) at the same parts by weight, the charge control agent was a polycondensed polymer (trade name “FCA-2521 NJ”, Fujikura Kasei Co., Ltd.) at 1.0 part by weight and the colorant was a magenta pigment (trade name “Pigment 57-1”, Dainichiseika Color & Chemicals Mfg. Co., Ltd.) at 6 parts by weight, the formulation was homogenously mixed, melt-kneaded, calendered and left to cool to obtain a kneaded product for composing a toner of Example 4.

Then, the kneaded product described above was coarsely ground, finely ground and classified in a manner similar to Example 1 to obtain a classified toner having a volume average particle diameter of 6.5 μm and a degree of circularity of 0.925.

Further, an external additive consisting of silica and titanium oxide to be described below was added to 100 parts by weight of the classified toner described above and blending was performed using a 10 L Henschel mixer at 2,500 rpm for five minutes to obtain a toner (external addition step).

Silica (Cabot Corporation, average primary particle diameter 10.5 nm, specific surface area 200 m²/g) 3.0 parts by weight

Titanium oxide (Fuji Titanium Industry Co., Ltd., primary particle diameter 300 nm, specific surface area 9 m²/g, treated with silicone oil) 0.7 part by weight

A magenta toner was obtained according to the steps described above.

Further, in a manner similar to the above except for replacing the magenta pigment described above with a cyan pigment (trade name “ECB301”, Dainichiseika Color & Chemicals Mfg. Co., Ltd.) and a yellow pigment (trade name “Fast Yellow 74-16”, Sanyo Color Works, Ltd.), cyan and yellow developers were obtained.

As described above, a non-magnetic, one-component color toner of Example 4 was produced.

### Example 5

In Example 5, in a manner similar to Example 4 except that the antistatic composition (X) was incorporated at 0.1 part by weight, a non-magnetic, one-component color toner of Example 5 was obtained.

### Example 6

In Example 6, in a manner similar to Example 4 except that the antistatic composition (X) was incorporated at 1.0 part by weight and the binder resin was ethylene-norbornene copolymer resin (Ticona, Mw 78,000, Mn 6,500, Tg 58° C.), a non-magnetic, one-component color toner of Example 6 was obtained.

### Comparative Example 3

In Comparative Example 3, in a manner similar to Example 4 except that the antistatic composition (X) was not incorporated, a non-magnetic, one-component color toner of Comparative Example 3 was obtained.

### Comparative Example 4

In Comparative Example 4, in a manner similar to Example 6 except that the antistatic composition (X) was not incorporated, a non-magnetic, one-component color toner of Comparative Example 4 was obtained.

Principal conditions for Examples and Comparative Examples are shown in Table 1.

TABLE 1

| | | Charge control | Antistatic |
|---|---|---|---|
| | | agent | composition (X) |
| | | incorporated | incorporated based |
| | | based on 100 pbw | on 100 pbw of |
| | Binder resins | of binder resin | binder resin |
| Ex. 1 | Polyester resin | 1.5 pbw | 0.25 pbw |
| Ex. 2 | Polyester resin | 1.5 pbw | 0.1 pbw |
| Ex. 3 | Ethylene- | 1.5 pbw | 1.0 pbw |
| | norbornene | | |
| | copolymer resin | | |
| Ex. 4 | Polyester resin | 1.0 pbw | 0.25 pbw |
| Ex. 5 | Polyester resin | 1.0 pbw | 0.1 pbw |
| Ex. 6 | Ethylene- | 1.0 pbw | 1.0 pbw |
| | norbornene | | |
| | copolymer resin | | |
| Com. Ex. 1 | Polyester resin | 1.5 pbw | None |
| Com. Ex. 2 | Ethylene- | 1.5 pbw | None |
| | norbornene | | |
| | copolymer resin | | |
| Com. Ex. 3 | Polyester resin | 1.0 pbw | None |
| Com. Ex. 4 | Ethylene- | 1.0 pbw | None |
| | norbornene | | |
| | copolymer resin | | |

<Evaluation of Non-Magnetic, Two-Component Toners>

(Electrical Resistance)

The toners of Examples 1 to 3 and Comparative Examples 1 and 2 were pelletized at a pressure of 200 kgf/cm² to a diameter of 2.5 cm and a thickness of 5.0 mm to measure electrical resistances. The results are shown in Table 2.

The two-component developers of Examples 1 to 3 and Comparative Examples 1 and 2 were filled into cartridges and a set of printing durability tests up to 50,000 sheets was carried out using a copying machine of two-component development system at a print rate of 4% and a print-out rate of 35 pages/min under low development potential and low transfer potential conditions (development voltage −250 V, primary transfer voltage 800 V).

After printing 1,000 and 50,000 sheets, sharpness of letters, image densities and fogging were evaluated.

(Sharpness of Letters)

Sharpness of letters was visually evaluated.

∘: no or very little toner scattering to periphery of letters, Δ: toner scattering to periphery of letters and x: very much toner scattering to periphery of letters, letters appearing blurred.

(Image Density)

Image densities were measured using a spectrodensitometer (trade name X-Rite 939, X-Rite, Incorporated).

∘: 1.1 or higher, Δ: 1.0 or higher and lower than 1.1, and x: lower than 1.0.

(Fogging)

Fogging was measured using a whiteness measuring instrument (trade name Colormeter 2000, Nippon Denshoku Industries Co., Ltd.) as a difference between whitenesses on non-imaged portion before and after printing.

∘: lower than 0.75, Δ: 0.75 or higher and lower than 1.0, and x: 1.0 or higher.

The results of evaluations of the non-magnetic, two-component toners are shown in Table 2.

TABLE 2

| | | Printing durability tests under low development | | | | | |
|---|---|---|---|---|---|---|---|
| | | potential and low transfer potential conditions | | | | | |
| | Electrical | Sharpness of | | Image | | | |
| | resistances | letters | | densities | | Fogging | |
| | (E10) Ω · cm | 1,000 | 50,000 | 1,000 | 50,000 | 1,000 | 50,000 |
| Ex. 1 | 3.0 | ∘ | ∘ | ∘ | ∘ | ∘ | ∘ |
| Ex. 2 | 5.1 | ∘ | ∘ | ∘ | ∘ | ∘ | ∘ |
| Ex. 3 | 5.9 | ∘ | ∘ | ∘ | ∘ | ∘ | ∘ |
| Com. | 9.5 | ∘ | Δ | Δ | x | ∘ | Δ |
| Ex. 1 | | | | | | | |
| Com. | 30.1 | ∘ | x | ∘ | x | ∘ | x |
| Ex. 2 | | | | | | | |

As shown in Table 2, in Example 1, the electrical resistance was relatively low at 3.0×10¹⁰ Ω·cm. The sharpness of letters, the image density and the fogging were all good regardless of the number of sheets printed.

In Example 2, the electrical resistance was somewhat higher at 5.1×10¹⁰ Ω·cm. However, the sharpness of letters, the image density and the fogging were all of no problem in practical use regardless of the number of sheets printed.

In Example 3, the electrical resistance was somewhat higher at 5.9×10¹⁰ Ω·cm. However, the sharpness of letters, the image density and the fogging were all of no problem in practical use regardless of the number of sheets printed.

In Examples 1 to 3, all characteristics remained good throughout the printing durability test by the antistatic composition suppressing the high electrical resistances derived from the resin.

On the contrary, in Comparative Example 1, the electrical resistance was high at 9.5×10¹⁰ Ω·cm. In addition, the sharpness of letters, the image density and the fogging degraded in evaluation along with an increase in the number of sheets printed. In particular, the image density after 50,000 sheets printed was lower than 1.0, causing a significant problem in practical use.

Also in Comparative Example 2, the electrical resistance was considerably high at 30.1×10¹⁰ Ω·cm. In addition, the sharpness of letters, the image density and the fogging degraded in evaluation along with an increase in the number of sheets printed. After 50,000 sheets printed, the sharpness of letters, the image density and the fogging all had a significant problem in practical use.

As described above, according to the present invention, color toners for electrophotography which provide sufficient image densities and show no ground fogging at low development potentials and low transfer potentials and are extended in life to such an extent that no problems in practical use may arise after printing 50,000 sheets may be provided.

Further, according to the present invention, since electrical resistances of toners can be adjusted with no assistance from electrically conductive external additives, color toners for electrophotography which will undergo no deterioration in sharpness of letters may be provided.

For reference, the two-component developers of Examples 1 to 3 and Comparative Examples 1 and 2 were filled into cartridges and a set of printing durability tests up to 50,000 sheets was carried out using a copying machine of two-component development system at a print rate of 4% and a print-out rate of 35 pages/min under high development potential and high transfer potential conditions (development voltage −400 V, primary transfer voltage 1500 V).

Then, in a manner similar to the above, after printing 1,000 and 50,000 sheets, sharpness of letters, image densities and fogging were evaluated.

The results are shown in Table 3.

TABLE 3

| | Printing durability tests under low development | | | | | |
|---|---|---|---|---|---|---|
| | potential and low transfer potential conditions | | | | | |
| | Sharpness | | Image | | | |
| | of letters | | densities | | Fogging | |
| | 1,000 | 50,000 | 1,000 | 50,000 | 1,000 | 50,000 |
| Ex. 1 | ∘ | ∘ | ∘ | ∘ | ∘ | ∘ |
| Ex. 2 | ∘ | ∘ | ∘ | ∘ | ∘ | ∘ |
| Ex. 3 | ∘ | ∘ | ∘ | ∘ | ∘ | ∘ |
| Com. | ∘ | Δ | ∘ | Δ | ∘ | x |
| Ex. 1 | | | | | | |
| Com. | ∘ | x | ∘ | x | ∘ | x |
| Ex. 2 | | | | | | |

As shown in Table 3, in Examples 1 to 3, the sharpness of letters, the image densities and the fogging were all good regardless of the number of sheets printed.

On the contrary, in Comparative Example 1, the sharpness of letters, the image density and the fogging degraded in evaluation along with an increase in the number of sheets printed. In particular, the fogging after 50,000 sheets printed was 1.0 or higher, causing a significant problem in practical use.

Also in Comparative Example 2, the sharpness of letters, the image density and the fogging degraded in evaluation along with an increase in the number of sheets printed. After 50,000 sheets printed, the sharpness of letters, the image density and the fogging all had a significant problem in practical use.

As described above, the toners according to the present invention can be used with no problem in practical use at high development potentials and high transfer potentials and, therefore, can be used in a wide variety of ways regardless of development potentials and transfer potentials inherent to copying machines and the like.

<Evaluation of Non-Magnetic, One-Component Toners>

(Electrical Resistance)

Electrical resistances of the toners of Examples 4 to 6 and Comparative Examples 3 and 4 were measured in a manner similar to the method of evaluation for the non-magnetic, two-component color toners of Examples 1 to 3 and Comparative Examples 1 and 2. The results are shown in Table 4.

The non-magnetic, one-component color toners of Examples 4 to 6 and Comparative Examples 3 and 4 were filled into cartridges and a set of printing durability tests up to 5,000 sheets was carried out using a printer of non-magnetic, one-component, 4-pass jumping development system at a print rate of 5% and a print-out rate of 5 pages/min.

Then, at every 1,000 sheets from the start to 5,000 sheets, sharpness of letters, image densities and fogging were evaluated according to the method of evaluation for the non-magnetic, two-component color toners of Examples 1 to 3 and Comparative Examples 1 and 2. Further, toner consumption and toner scattering inside the machine were evaluated.

(Toner Consumption)

For toner consumption, changes in weight of the printer before and after printing were measured and the amounts of toner needed to print 1,000 sheets (g/K) were calculated.

(Toner Scattering Inside the Machine)

Toner scattering inside the machine was visually evaluated.

∘: no or very little toner scattering to periphery of developing machine, Δ: toner scattering to periphery of developing machine and x: very much toner scattering to other peripheral members than developing machine.

The results are shown in Table 4.

TABLE 4

| | Electrical | | | | | | | |
|---|---|---|---|---|---|---|---|---|
| | resistances | Items | Number of sheets printed | | | | | |
| | (E10) Ω · cm | evaluated | Initial | 1,000 | 2,000 | 3,000 | 4,000 | 5,000 |
| Ex. 4 | 3.0 | Sharpness of | ∘ | ∘ | ∘ | ∘ | ∘ | ∘ |
| | | letters | | | | | | |
| | | Image | ∘ | ∘ | ∘ | ∘ | ∘ | ∘ |
| | | densities | | | | | | |
| | | Ground | ∘ | ∘ | ∘ | ∘ | ∘ | ∘ |
| | | fogging | | | | | | |
| | | Toner | 19.5 | 19.1 | 19.7 | 19.3 | 20.1 | 19.8 |
| | | consumption | | | | | | |
| | | (g/K) | | | | | | |
| | | Toner | ∘ | ∘ | ∘ | ∘ | ∘ | ∘ |
| | | scattering | | | | | | |
| | | inside | | | | | | |
| | | machine | | | | | | |
| Ex. 5 | 5.1 | Sharpness of | ∘ | ∘ | ∘ | ∘ | ∘ | ∘ |
| | | letters | | | | | | |
| | | Image | ∘ | ∘ | ∘ | ∘ | ∘ | ∘ |
| | | densities | | | | | | |
| | | Ground | ∘ | ∘ | ∘ | ∘ | ∘ | ∘ |
| | | fogging | | | | | | |
| | | Toner | 20.6 | 20.4 | 20.8 | 21.4 | 21.1 | 21.5 |
| | | consumption | | | | | | |
| | | (g/K) | | | | | | |
| | | Toner | ∘ | ∘ | ∘ | ∘ | ∘ | ∘ |
| | | scattering | | | | | | |
| | | inside | | | | | | |
| | | machine | | | | | | |
| Ex. 6 | 5.9 | Sharpness of | ∘ | ∘ | ∘ | ∘ | ∘ | ∘ |
| | | letters | | | | | | |
| | | Image | ∘ | ∘ | ∘ | ∘ | ∘ | ∘ |
| | | densities | | | | | | |
| | | Ground | ∘ | ∘ | ∘ | ∘ | ∘ | ∘ |
| | | fogging | | | | | | |
| | | Toner | 17.5 | 18.1 | 17.6 | 17.8 | 18.4 | 18.2 |
| | | consumption | | | | | | |
| | | (g/K) | | | | | | |
| | | Toner | ∘ | ∘ | ∘ | ∘ | ∘ | ∘ |
| | | scattering | | | | | | |
| | | inside | | | | | | |
| | | machine | | | | | | |
| Com. | 9.5 | Sharpness of | ∘ | ∘ | Δ | Δ | x | x |
| Ex. 3 | | letters | | | | | | |
| | | Image | ∘ | ∘ | ∘ | ∘ | ∘ | ∘ |
| | | densities | | | | | | |
| | | Ground | ∘ | ∘ | Δ | Δ | x | x |
| | | fogging | | | | | | |
| | | Toner | 19.7 | 20.5 | 24.6 | 27.4 | 30.1 | 34.2 |
| | | consumption | | | | | | |
| | | (g/K) | | | | | | |
| | | Toner | ∘ | ∘ | Δ | Δ | x | x |
| | | scattering | | | | | | |
| | | inside | | | | | | |
| | | machine | | | | | | |
| Com. | 30.1 | Sharpness of | ∘ | Δ | Δ | x | x | x |
| Ex. 4 | | letters | | | | | | |
| | | Image | ∘ | ∘ | ∘ | ∘ | ∘ | ∘ |
| | | densities | | | | | | |
| | | Ground | ∘ | Δ | Δ | x | x | x |
| | | fogging | | | | | | |
| | | Toner | 18.3 | 22.6 | 25.3 | 29.6 | 33.1 | 37.2 |
| | | consumption | | | | | | |
| | | (g/K) | | | | | | |
| | | Toner | ∘ | Δ | Δ | x | x | x |
| | | scattering | | | | | | |
| | | inside | | | | | | |
| | | machine | | | | | | |

As shown in Table 4, in Example 4, the electrical resistance was relatively low at 3.0×10¹⁰ Ω·cm. The sharpness of letters, the image density, the fogging, the toner consumption and the toner scattering inside the machine were all good regardless of the number of sheets printed.

In Example 5, the electrical resistance was somewhat higher at 5.1×10¹⁰ Ω·cm. However, the sharpness of letters, the image density, the fogging, the toner consumption and the toner scattering inside the machine were all of no problem in practical use regardless of the number of sheets printed.

In Example 6, the electrical resistance was somewhat higher at 5.9×10¹⁰ Ω·cm. However, the sharpness of letters, the image density, the fogging, the toner consumption and the toner scattering inside the machine were all of no problem in practical use regardless of the number of sheets printed.

In Examples 4 to 6, all characteristics remained good throughout the printing durability tests by the antistatic composition suppressing the high electrical resistances derived from the resin.

On the contrary, in Comparative Example 3, the electrical resistance was high at 9.5×10¹⁰ Ω·cm. In addition, the sharpness of letters, the image density, the fogging, the toner consumption and the toner scattering inside the machine degraded in evaluation along with an increase in the number of sheets printed. In particular, the toner scattering inside the machine after 4,000 sheets printed was at such a level that it could cause a significant problem in practical use.

Also in Comparative Example 4, the electrical resistance was considerably high at 30.1×10¹⁰ Ω·cm. In addition, the sharpness of letters, the image density and the fogging degraded in evaluation along with an increase in the number of sheets printed. After 4,000 sheets printed, the sharpness of letters, the image density, the fogging, the toner consumption and the toner scattering inside the machine all had a significant problem in practical use.

As described above, according to the present invention, color toners for electrophotography which, when used as non-magnetic, one-component toners, have less ground fogging, less toner consumption and no toner scattering inside the machine and output stable images without being influenced by changes in the installation environment during the period from the start of use to an exchange of toner cartridges may be provided.

In addition, according to the present invention, since electrical resistances of toners can be adjusted with no assistance from electrically conductive external additives and fluidity of the toners will not deteriorate, when used as non-magnetic, one-component toners, color toners for electrophotography which have stabilized image densities and can retain sharpness of letters may be provided.

Thereby, stable images can be output in non-magnetic, one-component development systems in which uniform electrification of toners is likely to be inhibited.

1. A color toner for electrophotography comprising, a binder resin, a colorant and an antistatic composition, the antistatic composition comprising:
(A) at least one member selected from a compound containing at least one ether linkage and/or at least one ester linkage and a (co)polymer containing at least one ether linkage and/or at least one ester linkage; and
(B) a component obtained by treating a metal salt of an alkali metal or alkaline earth metal with a compound capable of adsorbing anions.

2. The color toner for electrophotography according to claim 1, wherein the metal salt is lithium trifluoromethanesulfonate.

3. The color toner for electrophotography according to claim 1, wherein the antistatic composition is contained in an amount of 0.1 part by weight or more and less than 1.5 parts by weight, based on 100 parts by weight of the binder resin.

4. The color toner for electrophotography according to claim 1, which is a non-magnetic, two-component toner.

5. The color toner for electrophotography according to any one of claims 1 to 3, which is a non-magnetic, one-component toner.

6. The color toner for electrophotography according to claim 5, further comprising a mold release agent in an amount of 3 to 15% by weight.

7. The color toner for electrophotography according to claim 5, wherein a method for development is a jumping phenomenon.

8. The color toner for electrophotography according to claim 5, which has a volume average particle diameter of 5 to 8 μm and a number percent of particles 5 μm or less in diameter of 10 to 50%.
